(19) United States
(12) Patent Application Publication
(10) Pub. No.: US 2015/0326705 A1
(43) Pub. Date: Nov. 12, 2015

(54) Mobile Device Data Transfer Using Location Information

(71) Applicant: International Business Machines Corporation, Armonk, NY (US)

(72) Inventors: Ian Garnham, Winchester (GB); Tushita Jain, Bangalore (IN); Stuart J. Reece, Winchester (GB)

(21) Appl. No.: 14/706,501

(22) Filed: May 7, 2015

(30) Foreign Application Priority Data
May 8, 2014 (GB) 1408115.2

(51) Int. Cl. H04M 1/725; G06F 3/0488; H04W 8/20; G06F 3/0484; H04W 4/00; H04W 8/00

(52) U.S. Cl. CPC H04M 1/7253; H04W 4/008; H04W 8/005; H04W 8/20; G06F 3/0484; G06F 3/0488

(57) ABSTRACT

Method and system are provided for mobile device data transfer using location information carried out at a mobile sending device. The method includes: receiving a user gesture on a touch sensitive screen of the mobile sending device; determining the direction of the gesture based on an orientation of the mobile sending device; determining a location of the mobile sending device; combining the direction of the gesture and the location of the mobile sending device to give a three-dimensional direction from the mobile sending device. The method further includes identifying possible receiving devices currently at locations in the three-dimensional direction from the mobile sending device and transmitting data to a receiving device wirelessly.

### CROSS REFERENCE TO RELATED APPLICATION(S)

This application claims the benefit of priority to United Kingdom Patent Application No. 1408115.2, filed May 8, 2014, the contents of which are incorporated herein by reference.

### FIELD OF INVENTION

This invention relates to the field of transfer of data in the form of files, communication, or commands from a mobile device. In particular, the invention relates to transfer from a mobile device using location information.

### BACKGROUND OF INVENTION

Devices are becoming more prevalent and interconnected in society. There is a need for devices to become increasingly simpler to use to reach out to the masses. The transferring of data from one device to another is common, and conventionally requires significant configuration. Nowadays, there are some simple offerings, but there are downsides to these technologies.

A standard remote control device for appliances such as televisions, DVD players, CD players, etc. need to be pointed at the receiving device. Remote control devices are limited to basic control signals and need to have a line of sight to the receiving device.

Smartphone or tablet applications have been developed that act as a remote control device using Wi-Fi. For these applications to work, they must have been previously linked to the appliance that they are controlling. There is no knowledge of the position or orientation of the controlling device.

Bluetooth technology allows transfer of data between devices; however, the devices must be in close proximity to each other and must be paired by searching and recognizing another device.

Therefore, there is a need in the art to address the aforementioned problems.

### BRIEF SUMMARY OF THE INVENTION

According to a first aspect of the present invention there is provided a method for mobile device data transfer using location information carried out at a mobile sending device, comprising: receiving a user gesture on a touch sensitive screen of the mobile sending device; determining the direction of the gesture based on an orientation of the mobile sending device; determining a location of the mobile sending device; combining the direction of the gesture and the location of the mobile sending device to give a three-dimensional direction from the mobile sending device; identifying possible receiving devices currently at locations in the three-dimensional direction from the mobile sending device; transmitting data to a receiving device wirelessly.

The method may include determining current screen content on the mobile sending device and interpreting the received user gesture according to the current screen content.

If the step of identifying possible receiving devices currently at locations in the three-dimensional direction from the mobile sending device identifies two or more receiving devices, the method may include providing a prompt to the user to select a receiving device.

The method may include pairing a receiving device with the mobile sending device and receiving position updates from the paired receiving device.

The method may include receiving broadcast position information of an open receiving device.

Determining the direction of the gesture may include determining the direction of the gesture on the screen of the mobile sending device and the orientation of the mobile sending device based on one or more of: a digital compass, an accelerometer, and a gyroscope in the mobile sending device.

The method may include providing a display of identified receiving devices on the mobile sending device in the form of an augmented reality display and receiving a user gesture to one of the identified receiving devices on the display.

The data transfer may include one or more of the group of: file transfer, command transfer, communication transfer, transfer to a third device via a second device.

A receiving device may be one or more of the group of: a passive receiving device, a combined sending and receiving device, a mobile device, a fixed device, an intermediate device for onward data transfer.

The three-dimensional direction from the mobile sending device may be determined by the gesture is provided in the form of a direction vector and compared to a direction vector from a location of the mobile sending device to a receiving device.

According to a second aspect of the present invention there is provided a system for mobile device data transfer using location information comprising: a mobile sending device including: a touch sensitive screen for receiving a user gesture; a gesture direction component for determining the direction of the gesture based on an orientation of the mobile sending device; a location component for determining a location of the mobile sending device; a direction determining component for combining the direction of the gesture and the location of the mobile sending device to give a three-dimensional direction from the mobile sending device; an identifying component for identifying possible receiving devices currently at locations in the three-dimensional direction from the mobile sending device; a communication component for transmitting data to a receiving device wirelessly.

The system may include a current screen content component for determining current screen content on the mobile sending device and interpreting the received user gesture according to the current screen content.

The identifying component, if it identifies two or more receiving devices, may provide a prompt to the user to select a receiving device.

The system may include a pairing component for pairing a receiving device with the mobile sending device and receiving position updates from the paired receiving device.

The system may include a broadcast receiving component for receiving broadcast position information of an open receiving device.

The direction determining component may be for determining the direction of the gesture on the screen of the mobile sending device and the orientation of the mobile sending device based on one or more of: a digital compass, an accelerometer, and a gyroscope in the mobile sending device.

The system may include an augmented display for displaying identified receiving devices on the mobile sending device in the form of an augmented reality display and receiving a user gesture to one of the identified receiving devices on the display.

According to a third aspect of the present invention there is provided a computer program product for mobile device data transfer using location information carried out at a mobile sending device, the computer program product comprising a computer-readable storage medium having computer-readable program code embodied therewith, the computer-readable program code configured to: receive a user gesture on a touch sensitive screen of the mobile sending device; determine the direction of the gesture based on an orientation of the mobile sending device; determine a location of the mobile sending device; combine the direction of the gesture and the location of the mobile sending device to give a three-dimensional direction from the mobile sending device; identify possible receiving devices currently at locations in the three-dimensional direction from the mobile sending device; transmit data to a receiving device wirelessly.

According to a fourth aspect of the present invention there is provided a method substantially as described with reference to the figures.

According to a fifth aspect of the present invention there is provided a system substantially as described with reference to the figures.

The described aspects of the invention provide the advantage of providing an intuitive way to send data from one device to another when the devices are not next to each other.

### BRIEF DESCRIPTION OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a flow diagram of an example embodiment of a method in accordance with the present invention;

FIG. 2 is a schematic diagram illustrating an aspect of a method in accordance with the present invention;

FIG. 3 is block diagram of an example embodiment of a system in accordance with the present invention;

FIG. 4 is a block diagram of an embodiment of a computer system in which the present invention may be implemented;

FIG. 5 is a schematic diagram of a first example application of a system in accordance with the present invention; and

FIG. 6 is a schematic diagram of a second example application of a system in accordance with the present invention.

### DETAILED DESCRIPTION OF THE DRAWINGS

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Method and system are provided which allow a user to transfer data, communications, or commands from a first device to another device by gesturing from a first device towards another device to initiate the transfer. The method uses a combination of a gesture type and direction combined with knowledge of the relative positions of the sending device and the receiving device.

The method is simple to use and intuitive, as gestures are commonly known and understood. Using the method it is easy to send to multiple devices as the user just needs to gesture in another direction. In addition, as Wi-Fi or other wireless communication is used no line of sight is needed and the transfer may take place over large distances.

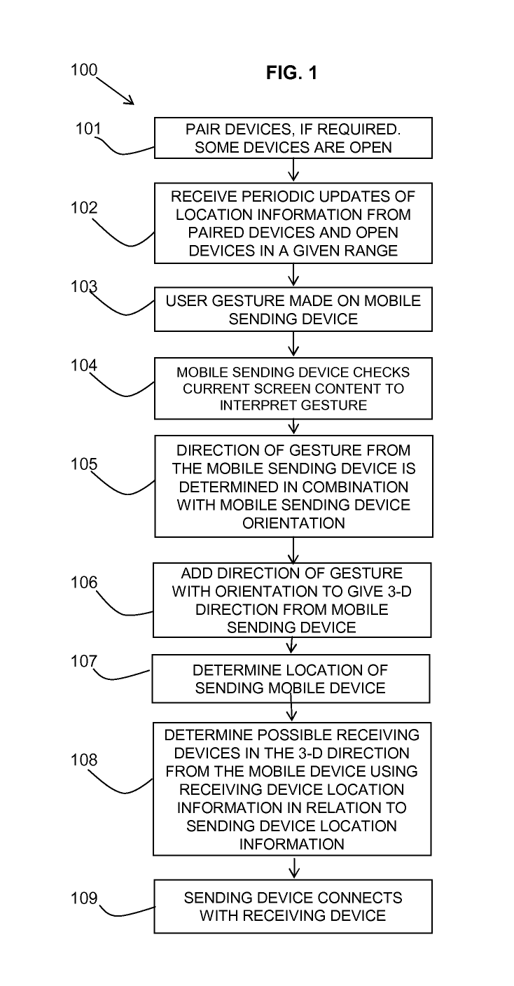

Referring to FIG. 1, a flow diagram 100 shows an example embodiment of the described method.

A mobile sending device and possible receiving devices may be paired 101 initially so that they know to trust one another. This would be along the lines of how pairing works with other devices over Wi-Fi and other wireless technologies. Additionally, some receiving devices may be open and therefore may receive data or commands from a mobile sending device without pairing.

Each of the receiving devices may regularly share 102 their location information with other devices that they are paired with, and may also send ad hoc location updates to paired devices, if a new location is detected (i.e. if they are moved). Open devices may broadcast their location which may be picked up by a sending device.

A user gesture on the mobile sending device is made 103. The mobile sending device may check 104 to see if it means data is to be transferred, communication made, or commands sent. The current screen content may be determined and a gesture may be interpreted in the context of the screen content. For example, a sideways swipe gesture on an e-reader application would mean to turn a page, whereas if the swipe gesture is on a locally stored video or photo and the gesture goes to the edge of the screen then the smartphone may interpret the gesture as meaning the media file is to be transferred to another device.

A direction of the gesture from the mobile sending device is determined 105 as well as the orientation of the mobile sending device using known technologies. Digital compasses may determine the horizontal direction, and accelerometers may determine whether the device is pointed up, down or rotated sideways.

The mobile sending device adds a direction of the gesture on the screen to the orientation of the phone, which gives 106 a three-dimensional direction from the mobile sending device. The current location of the sending mobile device is also determined 107.

Possible receiving devices in the direction from the mobile sending device are determined 108. Understanding device locations is well known as a technology, and can work from Global Positioning System (GPS) or Wi-Fi (e.g. Google location services). In this way, a mobile sending device which already knows its own location and the location of receiving devices can determine which of the sending devices are in the direction the user gestured towards.

The sending device may connect 109 with a receiving device. The method of communication is not key to the disclosure, although, in most cases, the communication may be via a Wi-Fi network. However, it could be over a standard mobile network which may give a greater range.

In cases where there are two or more receiving devices in the direction of the gesture, the user may be asked to confirm which is the correct receiving device, and then the data (e.g. media file) or command may be transferred.

As a further extension, as the mobile sending device would know the position of other trusted and open devices in the vicinity, these may be displayed on a smartphone via augmented reality. A user may be presented with a display showing receiving devices that can be connected to, even through walls and floors. Such augmented reality may ensure gesturing towards the intended device is more accurate if there is no line of sight to it. In one embodiment, a two-dimensional radar screen display may be provided which moves as the mobile sending device direction changes. In another embodiment, the mobile sending device may be held up to provide a camera view overlaid with icons representing receiving devices.

A mobile sending device knows it is pointing at a receiving device because:

a) it knows its own location (through existing GPS or location services);
b) it knows its own orientation through gyroscope data from within the mobile sending device; and
c) it knows the location of the receiving device as a result of an earlier pairing, and then occasional location updates being sent to the mobile sending device via Wi-Fi mobile data.

None of the technologies being employed require line of sight, which is why the presence or otherwise of a wall is irrelevant. It is for this reason that the method works through walls and over distances, so the mobile sending device is able to communicate with a receiving device, because it is approximately pointing at it. A second receiving device which is not being pointed at would not be communicated with.

However, if a second receiving device is close to the selected receiving device, then the sending device may be given a choice of which device to communicate with, effectively like augmented reality.

Position vector data for GPS or location services and sending device orientation may be readily obtained via existing application programming interfaces. The described method uses existing technologies in a combination, using position vectors.

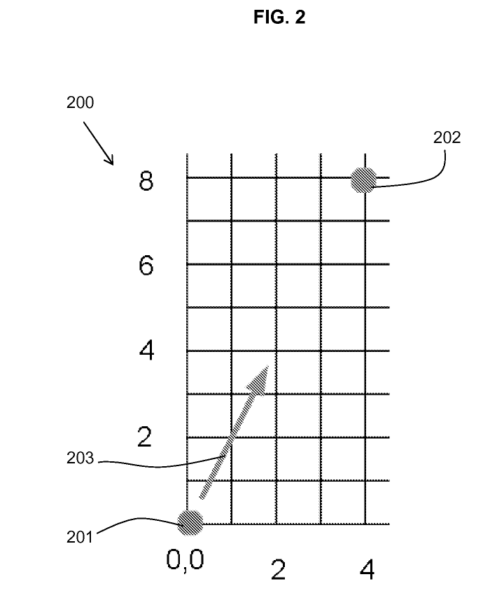

Referring to FIG. 2, a mapping 200 of a sending device 201 and a receiving device 202 is shown.

It should be noted that device gyroscopes work with 3D vectors, so there would be an extra dimension in the actual implementation. The example is limited to 2D for the purposes of illustration.

For simplicity in this example, the sending device 201 is the dot at coordinates (0,0). The current orientation of the sending device 201 is represented by the arrow 203 and has a position vector of (₄²) whereas the receiving device 202 shown as the dot at coordinates (4,8) can then be represented by the vector (₈⁴).

It is then determined if the sending device 201 is being pointed at the receiving device 202. This can be calculated by comparing the two position vectors for orientation of the sending device and the direction to the receiving device.

This may be carried out by a first method in which:

the orientation of the sending device is calculated as 2 divided by 4=0.5;

the direction of the receiving device is calculated as 4 divided by 8=0.5; and

the results compared, which in this case are identical.

Alternatively, this may be carried out by a second method in which:

calculate the multiplier from 1st value in orientation vector to 1st value in receiver vector;

calculate the multiplier from 2nd value in orientation vector to 2nd value in receiver vector; and

then compare the multipliers, which in this case are identical.

It is now know that the sending device is currently pointed at the receiving device. No line of sight is needed, as this was calculated using only location coordinates and position vectors.

Once it has been determined that the sending device is pointing at the receiving device, an existing, lightweight, and widely known protocol such as Message Queuing Telemetry Transport (MQTT) or other machine-to-machine connectivity protocol can then be used for device to device communication.

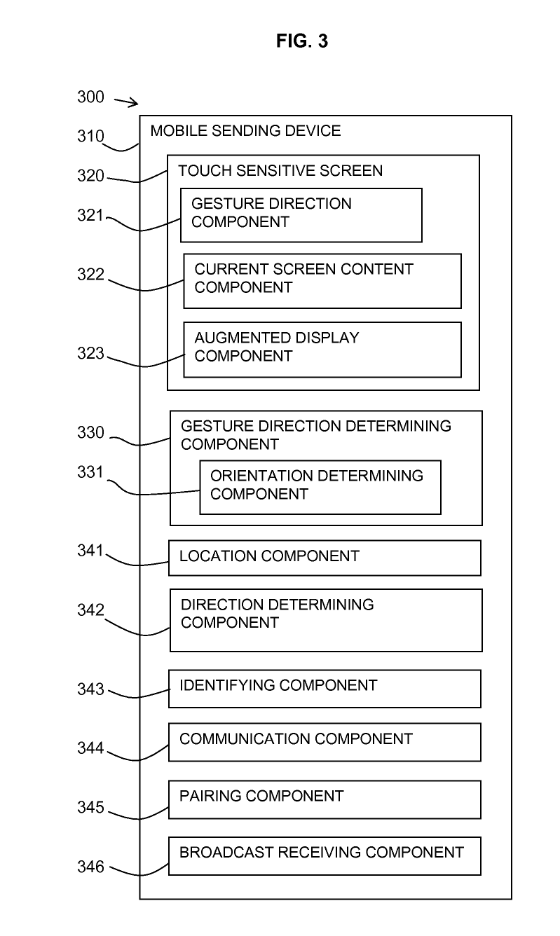

Referring to FIG. 3, a block diagram illustrates an example embodiment of the described system 300. The system includes a mobile sending device 310. The mobile sending device 310 may be a smartphone, tablet, laptop or other mobile computing device.

The system 300 includes the mobile sending device 310 having a touch sensitive screen 320 for receiving a user gesture and including a gesture direction component 321 for determining the direction of the gesture made on the screen 320. A gesture direction determining component 330 combines the direction of the gesture made on the screen 320 as determined by the gesture direction component 321 with an orientation of the mobile sending device 310 as determined by an orientation determining component 331. This provides a three-dimensional direction vector of a direction from the mobile sending device 310 that the user is indicating by making the gesture.

A pairing component 345 may pair the mobile sending device 310 with receiving devices and may receive location updates of receiving devices either periodically or when a receiving device moves. There may also be a broadcast receiving component 346 for receiving location update broadcasts from open receiving devices which are not specifically paired to the mobile sending device 310 but to which data may be transferred.

The mobile sending device 310 may include a location component 341 which may be a GPS component or location services component as often provided in smartphone or tablet devices. A direction determining component 342 may include a gyroscope or accelerometer device to determine the three-dimensional orientation of the device and may use the location information of the location component 341 in conjunction with the obtained three-dimensional direction vector of the direction that the user indicates to determine a direction from the location that receiving devices must be in.

An identifying component 343 may identify one or more receiving devices in the given direction based on the location information of the receiving devices obtained by the pairing component 345 and/or the broadcast receiving component 346.

A communication component 344 may enable network communication and transfer data from the mobile sending device to a receiving device in the given direction. If there is more than one receiving device in the given direction, a user may select the required device from a choice of receiving devices.

In one embodiment, a current screen content component 322 may be provided to determine the current content of the screen 320 when the gesture is made in order to correctly interpret the gesture.

In a further embodiment, an augmented display component 323 may be provided to provide an augmented display of identified receiving components to which the user may gesture to initiate a transfer of data. In one embodiment, a two-dimensional radar screen display may be provided which moves as the mobile sending device 310 direction changes. In another embodiment, the mobile sending device 310 may be held up to provide a camera view overlaid with icons representing receiving devices.

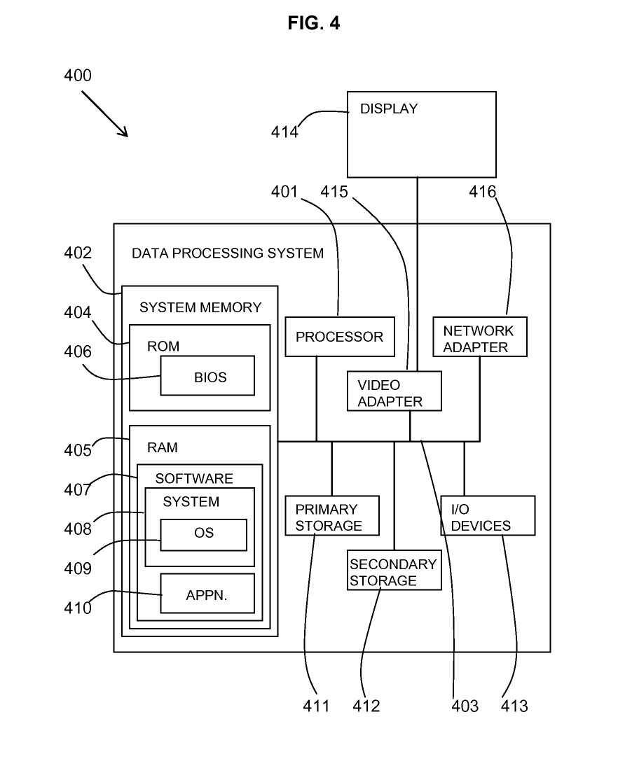

Referring to FIG. 4, an exemplary system for implementing aspects of the invention includes a data processing system 400 suitable for storing and/or executing program code including at least one processor 401 coupled directly or indirectly to memory elements through a bus system 403. The data processing system 400 may be any form of computing device, including but not limited to smartphones, tablets, laptops, desktop computers.

The memory elements may include local memory employed during actual execution of the program code, bulk storage, and cache memories which provide temporary storage of at least some program code in order to reduce the number of times code must be retrieved from bulk storage during execution.

The memory elements may include system memory 402 in the form of read only memory (ROM) 404 and random access memory (RAM) 405. A basic input/output system (BIOS) 406 may be stored in ROM 404. System software 407 may be stored in RAM 405 including operating system software 408. Software applications 410 may also be stored in RAM 405.

The system 400 may also include a primary storage means 411 such as a magnetic hard disk drive or flash (solid state) memory and secondary storage means 412 such as a magnetic disc drive and an optical disc drive. The drives and their associated computer-readable media provide non-volatile storage of computer-executable instructions, data structures, program modules and other data for the system 400. Software applications may be stored on the primary and secondary storage means 411, 412 as well as the system memory 402.

The computing system 400 may operate in a networked environment using logical connections to one or more remote computers via a network adapter 416.

Input/output devices 413 may be coupled to the system either directly or through intervening I/O controllers. A user may enter commands and information into the system 400 through input devices such as a keyboard, pointing device, touch screen, or other input devices. Output devices may include speakers, printers, etc. A display device 414 is also connected to system bus 403 via an interface, such as video adapter 415.

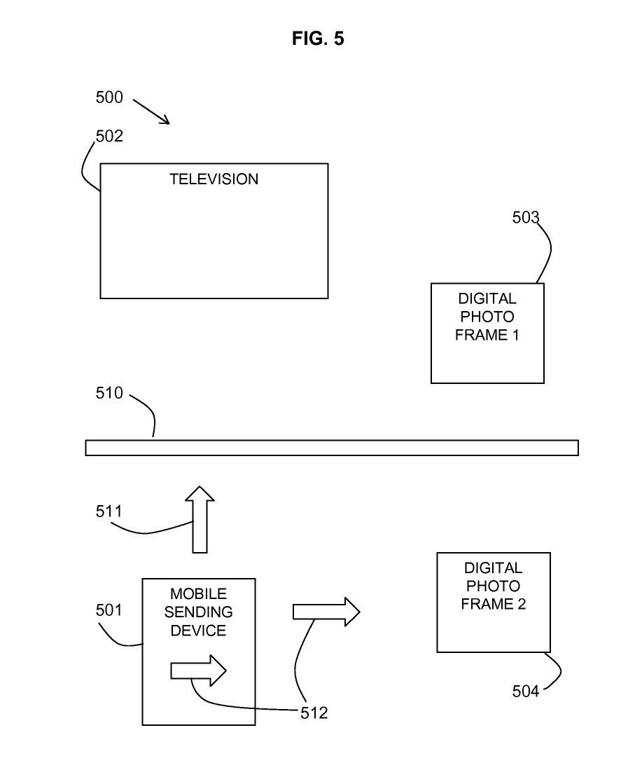

Referring to FIG. 5, a schematic diagram shows a first example application of the described system 500 in which a mobile sending device 501 in the form of a smartphone sends data and/or commands to a choice of a television 502, a first digital photograph frame 503 or a second digital photograph frame 504. The television 502 and first digital photograph frame 503 are shown to be on the opposite side of a wall 510 from the mobile sending device 501.

A user may send pictures to a television or digital photo frame by going through photos on a smartphone and gesturing, for example, by flicking, certain photo images at a Wi-Fi enabled television or digital photo frame in order to get them displayed. As the orientation of the gesture and the smartphone relative to the receiving device is known, the smartphone would not necessarily have to be pointed at the receiving device. If there are multiple devices in the room that could receive images then orientation is particularly important.

For example, in FIG. 5, the smartphone 501 is pointing towards the television 502 (direction A 511), but the user flicks an image in direction B 512 which is the same direction 512 as the second digital photo frame 504 so that the image is received by the second digital photo frame 504.

Appliances may be controlled from other parts of a building—such as adjusting the volume of a radio or television, from another part of the house by gesturing in the right direction (even through walls and floors), without affecting other radios or televisions, that could be controlled from the same sending device.

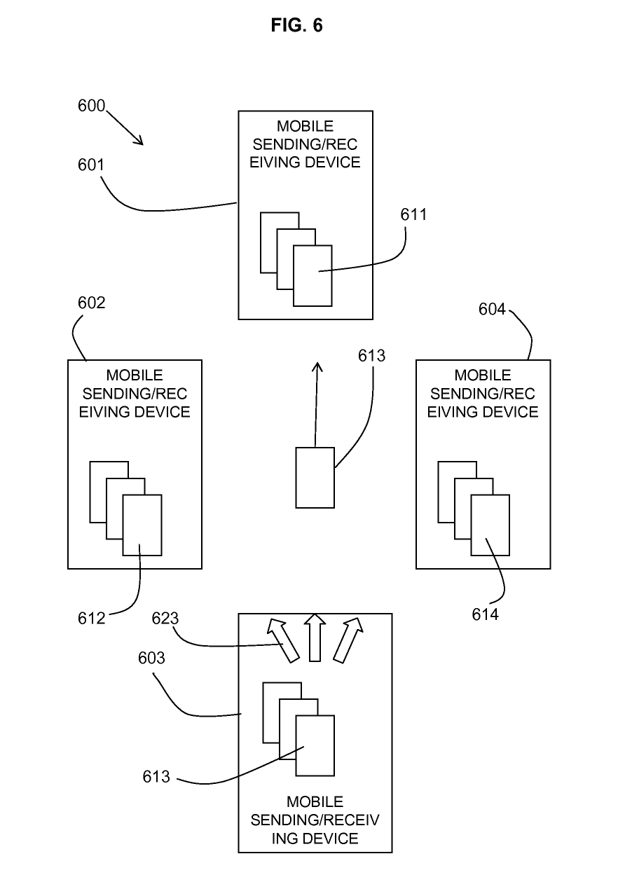

Referring to FIG. 6, a schematic diagram shows a second example application of the described system 600 in which multiple devices in the form of smartphones or tablets 601-604 each act as a sending device and a receiving device and are all mutually paired.

Users may set up a network of devices (e.g. smartphone, tablet, etc.) to play a game such as a game of playing cards, e.g. bridge, poker. Once the paired devices are connected, the gesturing method would be used to deal the cards, pick up cards, etc.

In FIG. 6, a third device 603 may be a dealer and may deal cards 613 from its display by making a swiping gesture 623 towards another device 601, 602, 603 to which a card 613 is to be transferred.

In another example application, a mobile sending device in the form of a smartphone may also be used to connect to another device (e.g. a laptop) to control the other device. Once connected then either via a gesture command or an options menu provided by the laptop to the smartphone, the user may instruct that laptop to send data (e.g. photos) to a third device (e.g. a television or digital photo frame).

For example, a smartphone, laptop, and digital photo frame have all been previously paired in a trusted network. A user may sit in one room with a smartphone and ‘see’ the laptop in the next room via augmented reality. By clicking on a laptop icon on the smartphone screen, the user is given a menu of possible actions. One is to transfer a file. If the user selects this option, then they are able to browse files on the laptop, for example, photos on the laptop as thumbnails. Once a file (for example, a photo) is chosen the user selects the thumbnail and is presented with a menu of actions, including “Copy”. The user selects this option, then on the main menu clicks on the digital photo frame icon to be given another menu. One of the menu options is “Paste”. By selecting the “Paste” option, the smartphone then instructs the laptop to send the photo to the digital photo frame.

In a further embodiment, different gestures may mean different things when using this functionality. For example, a first gesture may be used for transferring data, a second gesture for controlling a receiving device, and a third gesture for sending a command or communication.

The described method and system may also offer a way for business to reach out to customers. For example, a pedestrian passes a parked van with a company advert on the side, and the van has an ‘open’ receiving device inside. A passerby is interested in the advert, so a quick and specific gesture on his/her smartphone pointed in the direction of the van would cause a message to be sent to the receiving device in the van with “Contact me on I'd like a quote.”. Similarly a ‘pull’ gesture could cause the device in the van to send information and contact details of the company back to the passerby's smartphone. This would be a digital equivalent of taking a strip of paper with a phone number off a paper advert on a noticeboard.

The described method and system provides passive listening devices where no further action is necessary to receive communications or instructions, after the initial pairing. No synchronous gestures or 3rd party interface is needed.

The orientation of the sending device is used to give the user control of which devices are communicated with. The described method uses orientation as an additional control for the user, not as a requirement of the communication technology (i.e. not dependent on line of sight or close proximity).

There is no need for the sending and receiving devices to be close to each other, or even in the same room. This is because the method takes advantage of location services such as GPS.

The described method is a combination of gesture/command, location and orientation. This combination enables data to be transferred from one device to another using a gesture. The direction of a gesture, relative positions of the devices and the orientation of the sending device would all be used to denote which device data is being transferred to. Line of sight between sending and receiving devices is not required.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Improvements and modifications can be made to the foregoing without departing from the scope of the present invention.

1. A method for mobile device data transfer using location information carried out at a mobile sending device, comprising steps of:
receiving a user gesture on a touch sensitive screen of the mobile sending device;
determining a direction of the user gesture based on an orientation of the mobile sending device;
determining a location of the mobile sending device;
combining the direction of the user gesture and the location of the mobile sending device to give a three-dimensional direction from the mobile sending device;
identifying possible receiving devices currently at locations in the three-dimensional direction from the mobile sending device; and
transmitting data to a receiving device wirelessly.

2. The method as claimed in claim 1, further comprising:
determining current screen content on the mobile sending device and interpreting the received user gesture according to the current screen content.

3. The method as claimed in claim 1, further comprising wherein if the step of identifying possible receiving devices currently at locations in the three-dimensional direction from the mobile sending device identifies two or more receiving devices, providing a prompt to a user to select the receiving device.

4. The method as claimed in claim 1, further comprising:
pairing the receiving device with the mobile sending device and receiving position updates from the paired receiving device.

5. The method as claimed in claim 1, further comprising:
receiving broadcast position information of an open receiving device.

6. The method as claimed in claim 1, wherein determining the direction of the user gesture and the orientation of the mobile sending device is based on one or more of: a digital compass, an accelerometer, and a gyroscope in the mobile sending device.

7. The method as claimed in claim 1, further comprising:
providing a display of identified receiving devices on the mobile sending device in the form of an augmented reality display and receiving a user gesture to one of the identified receiving devices on the display.

8. The method as claimed in claim 1, wherein the data transfer includes one or more of the group of: file transfer, command transfer, communication transfer, and transfer to a third device via a second device.

9. The method as claimed in claim 1, wherein the receiving device is one or more of: a passive receiving device, a combined sending and receiving device, a mobile device, a fixed device, and an intermediate device for onward data transfer.

10. The method as claimed in claim 1, wherein the three-dimensional direction from the mobile sending device determined by the gesture is provided in the form of a direction vector and compared to a direction vector from a location of the mobile sending device to the receiving device.

11. A system for mobile device data transfer using location information, comprising:
a mobile sending device including:
a touch sensitive screen configured to receive a user gesture;
a gesture direction component configured to determine a direction of the user gesture based on an orientation of the mobile sending device;
a location component configured to determine a location of the mobile sending device;
a direction determining component configured to combine the direction of the user gesture and the location of the mobile sending device to give a three-dimensional direction from the mobile sending device;
an identifying component configured to identify possible receiving devices currently at locations in the three-dimensional direction from the mobile sending device; and
a communication component configured to transmit data to a receiving device wirelessly.

12. The system as claimed in claim 11, further comprising:
a current screen content component configured to determine current screen content on the mobile sending device and interpreting the received user gesture according to the current screen content.

13. The system as claimed in claim 11, wherein the identifying component is configured to provide a prompt to a user to select the receiving device responsive to identifying two or more receiving devices.

14. The system as claimed in claim 11, further comprising:
a pairing component configured to pair the receiving device with the mobile sending device and receiving position updates from the paired receiving device.

15. The system as claimed in claim 11, further comprising:
a broadcast receiving component configured to receive broadcast position information of an open receiving device.

16. The system as claimed in claim 11, wherein the direction of the user gesture and the orientation of the mobile sending device is based on one or more of: a digital compass, an accelerometer, and a gyroscope in the mobile sending device.

17. The system as claimed in claim 11, further comprising:
an augmented display configured to display identified receiving devices on the mobile sending device in the form of an augmented reality display and receiving a user gesture to one of the identified receiving devices on the display.

18. The system as claimed in any claim 11, wherein the data transfer includes one or more of: file transfer, command transfer, communication transfer, and transfer to a third device via a second device.

19. The system as claimed in claim 11, wherein the receiving device is one or more of the group of: a passive receiving device, a combined sending and receiving device, a mobile device, a fixed device, and an intermediate device for onward data transfer.

20. A computer program product for mobile device data transfer using location information carried out at a mobile sending device, the computer program product comprising a non-transitory computer-readable storage medium having computer-readable program code embodied therewith, the computer-readable program code configured to:
receive a user gesture on a touch sensitive screen of the mobile sending device;
determine the direction of the user gesture based on an orientation of the mobile sending device;
determine a location of the mobile sending device;
combine the direction of the user gesture and the location of the mobile sending device to give a three-dimensional direction from the mobile sending device;
identify possible receiving devices currently at locations in the three-dimensional direction from the mobile sending device; and
transmit data to a receiving device wirelessly.
